(19) United States
(12) Patent Application Publication
(10) Pub. No.: US 2004/0026948 A1
(43) Pub. Date: Feb. 12, 2004

(54) Side opening cargo covers for a midgate vehicle

(76) Inventor: Andrew J. Novajovsky, Grand Blanc, MI (US)

Correspondence Address: LAURA C. HARGITT, Genberal Motors Corporation, Legal Staff, Mail Code 482-C23-B21, P.O. Box 300, Detroit, MI, 48265-3000, US

(21) Appl. No.: 10/213,916

(22) Filed: Aug. 6, 2002

(51) Int. Cl. B62D 33/03; B62D 33/06

(52) U.S. Cl. 296/26.08; 296/32; 296/190.11

(57) ABSTRACT

A vehicle body is provided which has a passenger compartment, an adjacent cargo compartment and a midgate opening at the juncture of the compartments which is sufficiently expansive to provide complete accessibility between the compartments. The cargo compartment is defined, in part, by a bed flanked by a pair of sidewalls and a tailgate. A pair of hard covers, respectively, are hingedly connected to each sidewall and are sufficiently openable in a coplanar respect to the sidewall to which it is hingedly connected so that the midgate opening is fully accessible for cargo extending between the compartments and to the full extent of the opened hard covers.

### TECHNICAL FIELD

This invention relates to midgate vehicles having a cargo bed with openable covers.

### BACKGROUND OF THE INVENTION

Vehicles currently have cargo covers which are classified as either removable soft or hard covers or front-hinged hard covers. Soft covers may be snapped or connected with hook-and-loop connections to the sides of a pickup box or cargo bed of the vehicle or to the tailgate and a front rail. Hard covers conventionally have been mounted at the front of the cargo bed under the back glass and hinge up either manually or with a power lift mechanism. Covers have also been hinged to the sidewalls of a cargo bed as seen in U.S. Pat. No. 4,943,108, issued to Turnbull on Jul. 24, 1990. Turnbull, however, had no midgate opening.

A vehicle having a midgate, which separates a passenger compartment and a rear cargo box, loses functionality with such prior art covers. When the midgate is opened in the vehicle, the entire opening for the midgate is not usable with the hard covers of the prior art. The forward hinge location requires the cover to be removed and stored to fully use the midgate opening. Multi-piece covers have been used in the past, such as rail-mounted covers seen in U.S. Pat. No. 5,087,093, issued to Repetti, Feb. 11, 1992. Repetti has no midgate opening and one cover is permanently affixed to the bed so that full access to the space above the bed is precluded. Only removing a soft cover allows full usage of the cargo bed and easy compact storage of the cover. However, security may be compromised in such soft cover applications.

### SUMMARY OF THE INVENTION

This invention relates to vehicles, such as trucks, which have a midgate opening between the passenger compartment and the cargo compartment or truck bed. Vehicles with such midgate openings provide access for cargo loads to extend into the passenger compartment and provides added flexibility to the vehicle. This invention relates to vehicles having such midgate openings.

The invention has solid or hard covers mounted to the sidewalls of the vehicle. Half of the cover is mounted to each side of the truck bed. Hinges may be used for this purpose. When closed, the covers overlap and have a seal to protect cargo from the environment. Opening each half causes the cover to hinge upwardly ninety degrees to allow full access to the midgate opening between the passenger cab and the cargo bed. Additionally if the cover is structural, it may serve as additional sidewall height.

Accordingly, this invention is a vehicle body which has an enclosed passenger compartment, an adjacent cargo compartment and a midgate opening at the juncture of the compartments sufficiently expansive to provide complete accessibility between the compartments. The cargo compartment is defined, in part, by a cargo bed flanked by a pair of sidewalls and a tailgate. A pair of hard covers are respectively hingedly connected to the sidewalls and sufficiently openable to become coplanar with respect to one of the sidewalls to which they are hingedly connected so that the midgate opening is fully accessible and so that the cargo may extend between the compartments and to the full extent of the opened hard covers. The covers are sufficiently structural to provide sidewise support for cargo in the cargo compartment to the extent of the additional height of the sidewall when the hard covers are opened.

### BRIEF DESCRIPTION OF THE DRAWINGS

FIG. 1 is a perspective view of a vehicle body having an enclosed passenger compartment and an adjacent cargo bed closable by a tailgate, a midgate and the hard covers of the present invention;

FIG. 2 is a perspective view of the vehicle body shown in FIG. 1 without the tailgate and the midgate and with the covers of the present invention opened to expose fully a midgate opening on the vehicle and extend the sidewalls of the cargo bed;

FIG. 3 is a fragmentary schematic sectional view through the juncture of the closed covers and showing a seal;

FIG. 4 is a fragmentary perspective view with one of the covers of the present invention closed and hingedly connected with a piano hinge to the sidewall of the vehicle cargo bed;

FIG. 5 is a fragmentary perspective view with one of the covers closed and hingedly connected by a door hinge to the sidewall of the vehicle cargo bed; and

FIG. 6 is a fragmentary perspective view of the vehicle cargo bed with one of the hard covers of the present invention structural and in an open, upright, latched position coplanar with the sidewall of the cargo bed.

### DETAILED DESCRIPTION OF THE PREFERRED EMBODIMENTS

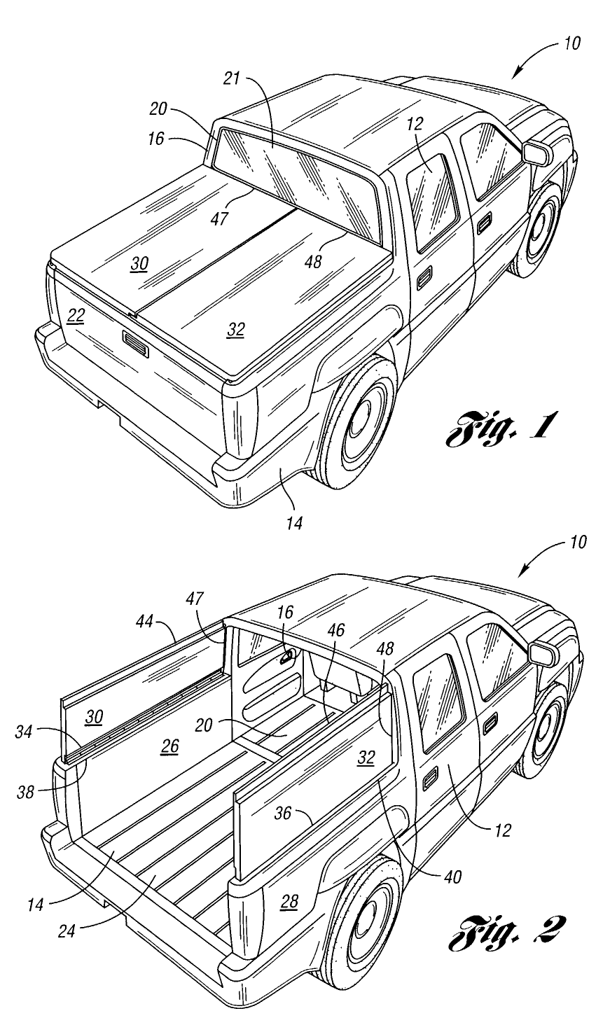

With reference to FIGS. 1 and 2, the vehicle body 10 has an enclosed passenger compartment 12 and an adjacent cargo bed or compartment 14. A midgate opening 16 is shown at the juncture of the cargo bed or compartment 14 and the passenger compartment 12. The opening is sufficiently expansive to provide complete accessibility between the cargo bed and the passenger compartment so that a cargo load can extend from the cargo bed into the passenger compartment. The midgate opening is closable by a midgate 20 which is removable or hingeable to clear the opening 16 for such complete accessibility. The midgate 20 may have a back glass panel 21. The cargo bed 14 is also closable by a tailgate 22.

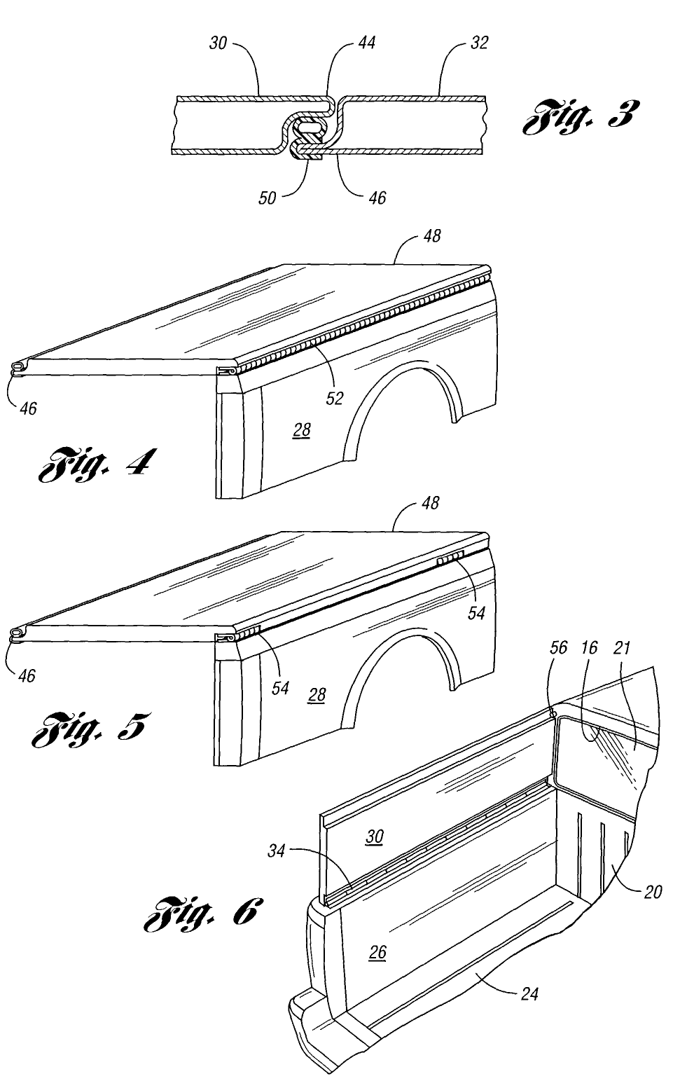

The cargo bed or compartment 14 has a cargo bed floor 24 and sidewalls 26,28. Hard covers 30 and 32 are hingedly connected respectively along their bottom sidewall edges 34,36 to the top edges 38,40 of the cargo bed or compartment sidewalls 26,28. The hinge 52, shown in FIG. 4, is a piano-type hinge, while the hinges 54, shown in FIG. 5, are door-type hinges.

When the covers 30,32 are in a closed position as in FIG. 2, the longitudinal edges 44,46 of the covers mate and have a seal 50 to interfit where the hard covers meet, shown in FIG. 3. Thus the pair of covers are sufficiently closable to mate longitudinally coextensive with a longitudinal dimension of the cargo compartment. Forward edges 47,48 of the covers 30,32 respectively have a seal (not shown) to interface with the back glass 21 or the midgate 20. The cargo bed or compartment 14 may be completely sealed when the covers are closed by providing another seal (not shown) around the tailgate 22 at the rear ends of the sidewalls 26,28 of the cargo bed.

The covers 30,32 are openable to an upright position, where they are substantially coplanar and upright with respect to the sidewalls 26,28 of the cargo bed. A latch or stop 56, as shown in FIG. 6, may be provided at the midgate opening to hold the covers 30,32 in their upright position. Each of the hard covers is sufficiently openable to reach the point where they are coplanar with the sidewalls of the cargo bed. At this point, the midgate opening 16 is fully accessible for cargo extending from the cargo bed into the passenger compartment and with the cargo stacked to the longitudinal edges 44,46 of the opened covers 30,32 and from sidewall 26 to sidewall 28, such as could occur in the view of FIG. 2.

In accordance with the present invention, and with reference to FIG. 2, the pair of hard covers is sufficiently structural to serve as additional height on the respective sidewall of the cargo bed when each hard cover is open and to contain and restrain the sideward thrust of the stacked load in the cargo bed against the additional height of the open hard covers. For this structural purpose, the hard covers may be pairs of sheet steel with stiffening ribs in between. Thus at least one of the pair of hard covers is sufficiently structural when open to serve as additional height on the respective sidewall and as sidewise support for cargo in the cargo compartment to the extent of the additional height.

The midgate 20 is configured to close the midgate opening 16 and may include the back glass panel 21 in an upper portion thereof above the closed hard covers as a complete closure for the passenger compartment, such as would occur when cargo is not to be extended between the passenger and cargo compartments. The midgate may be moved out of the pass-through expanse of the midgate opening by hinging it downwardly into the passenger compartment as a continuation of the cargo bed floor (FIG. 2) or by completely removing the midgate from the vehicle body.

While the best modes for carrying out the invention have been described in detail, those familiar with the art to which this invention pertains will recognize various alternative designs and embodiments for practicing the invention within the scope of the appended claims.

1. A vehicle body, comprising:
an enclosed passenger compartment;
an adjacent cargo compartment defined, in part, by a bed flanked by a pair of sidewalls and a tailgate;
a midgate opening at the juncture of the compartments sufficiently expansive to provide complete accessibility between the compartments; and
a pair of hard covers, respectively, hingedly connected to each sidewall and openable to an upright position coplanar with respect to the sidewall to which it is hingedly connected so that the midgate opening is fully accessible for cargo extending between the compartments.

2. The vehicle body of claim 1, wherein the covers are closable to a closed position, mating longitudinally coextensive with a longitudinal dimension of the cargo compartment.

3. The vehicle body of claim 2, further including a seal on at least one of the covers where the covers mate longitudinally.

4. The vehicle body of claim 1, wherein at least one of the pair of hard covers is sufficiently structural when open in its upright position to serve as additional height on the respective sidewall and as sidewise support for cargo in the cargo compartment to the extent of such additional height.

5. The vehicle body of claim 1, further including a latch at the midgate opening for latching at least one of the hard covers in its upright position.

6. The vehicle body of claim 1, further including a midgate for closing the midgate opening.

7. The vehicle body of claim 6, wherein the hard covers are closable to a closed position and the midgate includes a glass panel above the hard covers when in their closed position.

8. A vehicle body, comprising:
a passenger compartment;
an adjacent cargo compartment having a cargo bed defined, in part, by the cargo bed flanked by a pair of sidewalls and a tailgate;
a midgate opening at the juncture of the compartments sufficiently expansive to provide complete accessibility between the compartments, and a midgate moveably connected to the vehicle body for opening the expanse of the midgate opening; and
a pair of hard covers, respectively hingedly connected to each sidewall and sufficiently openable in a coplanar respect to the sidewall to which it is hingedly connected so that the midgate opening is fully accessible for cargo extending between the compartments on the cargo bed; and
said pair of hard covers being sufficiently structural to serve as additional height on the respective sidewall when each hard cover is open to contain and restrain the cargo by the open hard covers.

9. A vehicle body, comprising:
a passenger compartment;
an adjacent cargo compartment defined, in part, by a bed flanked by a pair of sidewalls and a tailgate;
a midgate opening between the compartments; and
a pair of hard covers, respectively, hingedly connected to each sidewall and pivotable between a closed position perpendicular to the sidewalls and an open position substantially parallel to the sidewalls so that the midgate opening is unobstructed to enable cargo to extend between the compartments.
